(19) United States
(12) Patent Application Publication
(10) Pub. No.: US 2018/0267365 A1
(43) Pub. Date: Sep. 20, 2018

(54) MATRIX FOR QUANTUM DOT ARTICLES

(71) Applicant: 3M INNOVATIVE PROPERTIES COMPANY, St. Paul, MI (US)

(72) Inventors: Karissa L. ECKERT, Ham Lake, MN (US); Eric W. NELSON, Stillwater, MN (US); Wayne S. MAHONEY, St. Paul, MN (US)

(21) Appl. No.: 15/762,492

(22) PCT Filed: Sep. 23, 2016
(86) PCT No.: PCT/US2016/053339

§ 371 Date: Mar. 22, 2018

Related U.S. Application Data
(60) Provisional application No. 62/232,071, filed on Sep. 24, 2015.

(51) Int. Cl. G02F 1/1335; C09J 133/10; F21V 9/32; G02B 5/02; B32B 7/12; B32B 27/08; B32B 27/36; B32B 37/24

(52) U.S. Cl. CPC G02F 1/133617; B32B 2310/0831; F21V 9/32; G02B 5/0294; G02B 5/0242; B32B 7/12; B32B 27/08; B32B 27/36; B32B 37/24; B32B 2255/10; B32B 2255/20; B32B 2255/26; B32B 2457/202; B32B 2037/243; C09J 133/10

(57) ABSTRACT

A quantum dot film article includes a first barrier layer; a second barrier layer; and a quantum dot layer between the first barrier layer and the second barrier layer. The quantum dot layer includes quantum dots dispersed in a matrix including a cured radiation curable adhesive composition with external quantum efficiency of greater than about 70%. The radiation curable adhesive composition includes about 30 wt % to about 99 wt %, based on the total weight of the radiation curable adhesive composition, of a multifunctional monomer, multifunction oligomer, or mixture thereof, wherein the multifunctional monomer includes (meth)acryl functional groups on a backbone.

### BACKGROUND

Liquid crystal displays (LCDs) are non-emissive displays that utilize a separate backlight unit and red, green, and blue color filters for pixels to display a color image on a screen. The red, green, and blue color filters respectively separate white light emitted from the backlight unit into red, green, and blue light. The red, green, and blue color filters each transmit only light of a narrow wavelength band and absorb the rest of the visible spectrum, resulting in significant optical loss. Thus, the LCD needs a high luminance backlight unit to produce an image with sufficient luminance. The range of colors that can be displayed by a LCD device, referred to as color gamut, is determined by the combined spectra of the backlight unit and the color filters of the LCD panel. Thicker, more absorbing color filters result in more saturated primary colors and a broader range of color gamut, although at the cost of reduced luminance.

Quantum dot film articles include quantum dots dispersed in a matrix that is laminated between two barrier layers. The quantum dot film articles, which include combinations of green and red quantum dots as fluorescing elements, can enhance color gamut performance when used in LCDs.

An adhesive composition including a two-part thermally accelerated epoxy amine has been used as a matrix material for quantum dot film articles. The epoxy amine adhesive composition supports the quantum dots, provides a barrier to reduce ingress of oxygen and moisture that can degrade the quantum dots, and adheres the barrier films together. During curing of the epoxy amine adhesive composition, high cure temperatures can induce defects in the laminate construction.

A relatively small amount of a radiation curable methacrylate compound can be added to the epoxy amine adhesive composition to provide greater control over coating, curing, and web handling of the laminate construction without reducing the functional properties of the epoxy amine polymer. Optionally, a 100% radiation curable system can be used.

### SUMMARY

High curing temperatures and slow cure rates for the epoxy amine adhesive composition can damage the quantum dot articles by causing damage to the barrier films such as shrinkage, winkles, curl, and the like during curing. Maintaining a low curing temperature to limit damage to the barrier films can limit manufacturing line speeds and can require that the curing oven have an extended length.

The present disclosure provides a radiation curable adhesive composition that can be cured quickly at a low temperature to provide a matrix for a quantum dot film article. In some embodiments, the radiation curable adhesive composition can be cured directly after coating the composition at room temperature or a moderate temperature of less than about 100° C., which can improve cure rates and can reduce defects in the quantum dot film article caused by high temperature curing. Slowing or eliminating quantum dot degradation is particularly important to extend the service life of the displays in smaller electronic devices such as those utilized in, for example, handheld devices and tablets. The cured adhesive compositions also resist ingress from water and/or oxygen, produce and maintain acceptable color initially and upon aging, and produce and maintain acceptable effective quantum efficiency initially and upon aging.

In one embodiment, the present disclosure is directed to a quantum dot film article that includes a first barrier layer; a second barrier layer; and a quantum dot layer between the first barrier layer and the second barrier layer. The quantum dot layer includes quantum dots dispersed in a matrix including a cured radiation curable adhesive composition with external quantum efficiency of greater than about 70%. The radiation curable adhesive composition includes about 30 wt % to about 99 wt %, based on the total weight of the radiation curable adhesive composition, of a multifunctional monomer, multifunction oligomer, or mixture thereof, wherein the multifunctional monomer includes methacryl functional groups on a backbone.

In another embodiment, the present disclosure is directed to a quantum dot film article including a first barrier layer; a second barrier layer; and a quantum dot layer between the first barrier layer and the second barrier layer. The quantum dot layer includes quantum dots in a matrix including a cured radiation curable adhesive composition with an external quantum efficiency of greater than about 70%. The quantum dots are dispersed in an amino-functional silicone oil. The radiation curable adhesive composition includes about 50 wt % to about 95 wt %, based on the total weight of the radiation curable adhesive composition, of a difunctional monomer or oligomer with two methacryl functional groups on a backbone derived from bisphenol A; about 1 wt % to about 30 wt %, based on the total weight of the radiation curable adhesive composition, of at least one monofunctional monomer or oligomer with a (meth)acryl functional group; and a photoinitiator.

In another embodiment, the present disclosure is directed to a method of forming a quantum dot film article including coating a quantum dot material on a first polymeric film. The quantum dot material includes quantum dots in an adhesive composition. The adhesive composition includes about 30 wt % to about 99 wt %, based on the total weight of the radiation curable adhesive composition, of a difunctional monomer or oligomer with two methacryl functional groups on a backbone derived from bisphenol A; and a photoinitiator. The difunctional monomer or oligomer with two methacryl functional groups on a backbone derived from bisphenol A has an acid value from the presence of hydroxyl or carboxylic acid groups of greater than about 0.2 mg of KOH/g.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic side elevation view of an edge region of an illustrative film article including quantum dots.

FIG. 2 is a flow diagram of an illustrative method of forming a quantum dot film.

FIG. 3 is a schematic illustration of an embodiment of a display including a quantum dot film article.

FIG. 4 is a schematic illustration of a white point measurement system used in the examples of the present disclosure.

Like symbols in the drawings indicate like elements.

### DETAILED DESCRIPTION

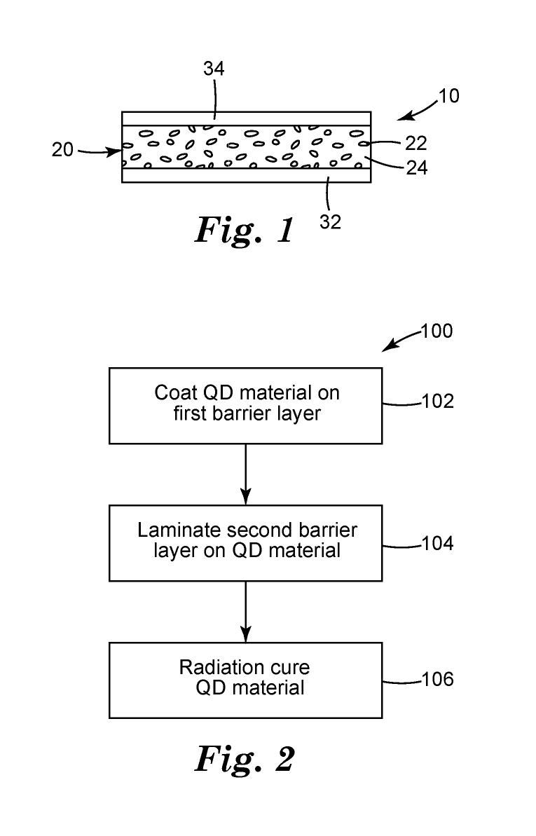

Referring to FIG. 1, an edge region of a quantum dot article 10 includes a first barrier layer 32, a second barrier layer 34, and a quantum dot layer 20 between the first barrier layer 32 and the second barrier layer 34. The quantum dot layer 20 includes a plurality of quantum dots 22 dispersed in a matrix 24.

The barrier layers 32, 34 can be formed of any useful material that can protect the quantum dots 22 from exposure to environmental contaminates such as, for example, oxygen, water, and water vapor. Suitable barrier layers 32, 34 include, but are not limited to, films of polymers, glass and dielectric materials. In some embodiments, suitable materials for the barrier layers 32, 34 include, for example, polymers such as polyethylene terephthalate (PET); oxides such as silicon oxide, titanium oxide, zirconium oxide, or aluminum oxide (e.g., SiO₂, Si₂O₃, TiO₂, ZrO2 or Al₂O₃); and suitable combinations thereof.

In some embodiments, each barrier layer 32, 34 of the quantum dot article 10 includes at least two sub-layers of different materials or compositions. In some embodiments, such a multi-layered barrier construction can more effectively reduce or eliminate pinhole defect alignment in the barrier layers 32, 34, providing a more effective shield against oxygen and moisture penetration into the matrix 24. The quantum dot article 10 can include any suitable material or combination of barrier materials and any suitable number of barrier layers or sub-layers on either or both sides of the quantum dot layer 20. The materials, thickness, and number of barrier layers and sub-layers will depend on the particular application, and can be selected to maximize barrier protection and brightness of the quantum dots 22 while minimizing the thickness of the quantum dot article 10. In some embodiments each barrier layer 32, 34 is itself a laminate film, such as a dual laminate film, where each barrier film layer is sufficiently thick to eliminate wrinkling in roll-to-roll or laminate manufacturing processes. In one illustrative embodiment, the barrier layers 32, 34 are polyester films (e.g., PET) having an oxide layer.

The quantum dot layer 20 can include one or more populations of quantum dots or quantum dot materials 22. Exemplary quantum dots or quantum dot materials 22 emit light when excited by ultraviolet or visible light below the excitation wavelength of the quantum dots. In some embodiments, for example, the quantum dot materials 22 emit green light and red light upon down-conversion of blue primary light from a blue LED to secondary light emitted by the quantum dots. The respective portions of red, green, and blue light can be controlled to achieve a desired white point for the white light emitted by a display device incorporating the quantum dot article 10. Exemplary quantum dots 22 for use in the quantum dot articles 10 include, but are not limited to, CdSe with ZnS shells. Suitable quantum dots for use in quantum dot articles described herein include, but are not limited to, core/shell luminescent nanocrystals including CdSe/ZnS, CdSe/CdS/ZnS, InP/ZnS, PbSe/PbS, CdSe/CdS, CdTe/CdS or CdTe/ZnS. In various embodiments, the luminescent nanocrystals can include surface ligands or coatings or can be stabilized as a salt. In exemplary embodiments, the luminescent nanocrystals include an outer ligand coating and are dispersed in a polymeric matrix. Quantum dot and quantum dot materials 22 are commercially available from, for example, Nanosys Inc., Milpitas, Calif. The quantum dot layer 20 can have any useful amount of quantum dots 22, and in some embodiments the quantum dot layer 20 can include from 0.1 wt % to 1 wt % quantum dots, based on the total weight of the quantum dot layer 20.

In some embodiments, the quantum dot materials can include quantum dots dispersed in a liquid carrier. In one non-limiting example, the liquid carrier can include an amino-functional silicone ligand, which can also scatter light and improve utilization of the quantum dots. In one example embodiment, the quantum dot materials include CdSe quantum dots with ZnS shells, and the CdSe/ZnS quantum dots are dispersed in an amino silicone oil.

In one or more embodiments the quantum dot layer 20 can optionally include scattering beads, particles or emulsions that scatter light. In various embodiments, these scattering beads, particles and emulsions have a refractive index that differs from the refractive index of the matrix material 24 by at least 0.05, or by at least 0.1. The scattering beads, particles and emulsions can include, for example, polymers such as silicone, acrylic, nylon, and the like, or inorganic materials such as TiO₂, SiOₓ, AlOₓ, and the like, and combinations thereof. In some embodiments, including scattering particles in the quantum dot layer 20 can increase the optical path length through the quantum dot layer 20 and improve quantum dot absorption and efficiency. In many embodiments, the scattering beads or particles have an average particle size from 1 μm to 10 μm, or from 2 μm to 6 μm. In some embodiments, the quantum dot material 20 can optionally include fillers such as fumed silica.

The matrix 24 of the quantum dot layer 20 can be formed from an adhesive that effectively adheres to the materials forming the barrier layers 32, 34 to form a laminate construction, and also forms a protective matrix for the quantum dots 22. In one embodiment, the matrix 24 is formed by curing or hardening a radiation curable adhesive composition including a combination of monofunctional, difunctional, and multifunctional monomers or oligomers with (meth)acryl functional groups on a backbone. In some embodiments, at least some of the monofunctional, difunctional, and multifunctional monomers or oligomers with (meth)acryl functional groups on a backbone have an acid value from the presence of hydroxyl or carboxylic acid groups of greater than about 0.2 mg of KOH/gram as measured, for example, by ASTM test method D4662-08 “Standard Test Methods for Polyurethane Raw Materials: Determination of Acid and Alkalinity Numbers of Polyols” from ASTM International, West Conshohocken, Pa. In this application the term oligomer refers to a polymer including only a few monomeric units, generally having a weight average molecular weight of less than about 10,000 daltons. In this application the term (meth)acryl refers to acryl functional groups, methacryl functional groups, and mixtures and combinations thereof.

In one embodiment, the radiation curable adhesive composition includes a difunctional monomer, oligomer, or mixture thereof having two methacryl functional groups on a backbone. In some embodiments, the difunctional monomer or oligomer includes a single methacryl functional group on each end of the backbone. A wide variety of backbone chemistries can be selected to provide a quantum dot matrix with good initial and aged optical properties, as well as good barrier and physical properties.

In one embodiment, which is not intended to be limiting, the backbone of the difunctional methacryl monomer or oligomer is derived from bisphenol A or bisphenol F. Suitable commercially available monomers or oligomers include oligomers such as those generally known as epoxy methacrylates obtained, for example, from the reaction of difunctional epoxy resins reacted with two equivalents of methacrylic acid, or from the reaction of a multi-functional polyol with two equivalents of glycidyl methacrylate. Examples of a suitable bisphenol A-based epoxy methacrylate oligomer include, but are not limited to, those available under the trade designation CN154 from Sartomer Americas, Exton Pa., and resorcinol based epoxy methacrylate oligomers such as those available under the trade designation NEOPOL 8313 from Japan U-Pica Company, Ltd (Tokyo Japan) and DENACOL DM-201 from Nagase ChemteX Corporation (Osaka, Japan). Epoxy methacrylate oligomers derived from poly(ethylene glycol) can also be used and are available under the trade designation DENACOL DM-811, DM-832, and 851, all from Nagase ChemteX Corporation (Osaka, Japan). Other suitable commercially available monomers and oligomers include ethoxylated bisphenol A dimethacrylates such as those available under the trade designations SR348, CD540, SR541, CD542, and SR480 from Sartomer Americas.

In various embodiments, the monomers and oligomers have an acid value from the presence of hydroxyl or carboxylic acid groups of greater than or equal to 0.2 mg of KOH/g, or greater than or equal to about 0.5 mg of KOH/g, or greater than or equal to 1.0 mg of KOH/g as measured, for example, by ASTM test method D4662-08 “Standard Test Methods for Polyurethane Raw Materials: Determination of Acid and Alkalinity Numbers of Polyols” from ASTM International, West Conshohocken, Pa.

Additional examples include polyalkylene glycol dimethacrylates such as polyethylene glycol (600) dimethacrylate (SR252), polyethylene glycol (400) dimethacrylate (SR603), and polypropylene glycol (400) dimethacrylate (SR644), all available from Sartomer Americas. Further examples include bisphenol methacrylic compounds such as bisphenol A ethoxylate dimethacrylate and bisphenol A glycerolate dimethacrylate available from Sigma-Aldrich, St. Louis, Mo., and 1,3 butanediol dimethacrylate (1,3-BDDMA), diethylene glycol dimethacrylate (DEGDMA), ethylene glycol dimethacrylate (EGDMA), polyethylene glycol 200 dimethacrylate (PEG200DMA), and triethylene glycol dimethacrylate (T3EGDMA) available from BASF Resins, Wyandotte, Mich., as well as hydroxyl-containing monomers such as glycerol dimethacrylate, and mixtures thereof. Examples of suitable multifunctional monomers and oligomer include trimethylolpropane trimethyacrylate (TMPTA) and ethyoxylated trimethylolpropane trimethyacrylate resins such as SR9035 and SR415 from Sartomer Americas (Exton, Pa.) and ethoxylated glycerine trimethacrylate resins available from Shin-Nakamura Chemical Company (Wakayama, Japan).

In various embodiments, the difunctional monomer or oligomer having two methacryl functional groups on a backbone is present in the adhesive composition at about 30 wt % to about 99 wt %, or about 50 wt % to about 99 wt %, or about 70 wt % to about 95 wt %, based on the total weight of the adhesive composition.

Presently available evidence suggests that multifunctional acrylates are not preferred for use in the radiation curable adhesive composition. While not wishing to be bound by any theory, the multifunctional acrylates appear to undergo Michael Addition with the amine stabilizing ligand quantum dot carrier liquid and result in a solution that is unstable. As shown in more detail in the examples below, a radiation curable adhesive composition with higher functionality acrylates (two or more acryl functional groups) will cure or gel in a relatively short time frame (less than about 24 hours) when the quantum dots in amine stabilizing ligands are added. As further shown in detail in the examples below, quantum dot films film articles made with multifunctional acrylates also have relatively poor aging stability.

In some embodiments, the radiation curable adhesive composition may optionally further include a monofunctional monomer, monofunctional oligomer, or mixtures thereof having (meth)acryl functionality, wherein (meth)acryl refers to acrylates and methacrylates.

In other embodiments, the radiation curable adhesive composition optionally includes a monofunctional (meth)acrylate monomer or oligomer such as, for example, 2-phenoxyethyl acrylates available from Sartomer, USA, LLC under the trade designation SR 339. Other suitable (meth)acryl monomers or oligomers that can be used in the radiation curable adhesive composition include, but are not limited to, methyl (meth)acrylate, n-butyl (meth)acrylate, ethyl (meth)acrylate, 2-methylbutyl (meth)acrylate, isooctyl (meth)acrylate, 2-ethylhexyl (meth)acrylate, isononyl (meth)acrylate, decyl (meth)acrylate, dodecyl (meth)acrylate, hexyl (meth)acrylate, isobornyl (meth)acrylate, octadecyl (meth)acrylate, -phenoxyethyl methacrylate available from Sartomer, USA, LLC under the trade designation SR 340, behenyl methacrylate, cyclohexyl (meth)acrylate, iso-tridecyl (meth)acrylate, lauryl (meth)acrylate, stearyl (meth)acrylate, tert-butyl methacrylate, ureido methacrylate, 4-tert-butyl cyclohexyl (meth)acrylate, benzyl (meth)acrylate, tetrahydrofurfuryl (meth)acrylate, gamma-butyrolactone (meth)acrylate, dicyclpentenyloxyethyl methacrylate (such as FA-512M from Hitachi Chemical, Tokyo Japan) and dicyclpentanyl methacrylate (such as FA-513M from Hitachi Chemical), phenoxyethyl (meth)acrylate, alkoxylated alkyl(meth)acrylates such as e.g. ethoxyethoxyethyl(meth)acrylate, ethoxyethyl(meth)acrylate, methoxyethyl(meth)acrylate, methoxyethoxyethyl(meth)acrylate, and mixtures thereof. Examples of suitable monofunctional oligomers include, but are not limited to, hydroxyl-functional or methoxy-functional polyethyleglycol (meth)acrylates such as SR551, SR550, CD553, CD552 from Sartomer Americas, Exton, Pa. Hydroxy-containing (meth)acrylate monomers may also be used, such as glycerol monomethacrylate, 2-hydroxyethyl (meth)acrylate, 3-hydroxypropyl (meth)acrylate, 4-hydroxybutyl (meth)acrylate, 3-phenoxy-2-hydroxy propyl methacrylate (Polysciences, Inc. Warrington, Pa.), and 3-phenoxy-2-hydroxy propyl acrylate available under the trade designation Denacol DA-141 from Nagase America, New York, N.Y. Also suitable are amine-containing methacrylate monomers, such as N,N-dimethylaminoethyl methacrylate (DMAEMA), N,N-diethylaminoethyl methacrylate (DEAEMA), and tert-butylaminoethyl methacrylate (TBAEMA), all from BASF (Florham Park, N.J.).

In various embodiments, the monofunctional monomer or oligomer with a single (meth)acryl functional group on a backbone is present in the adhesive composition at about 0 wt % to about 25 wt %, or about 5 wt % to about 20 wt %, or about 5 wt % to about 15 wt %, based on the total weight of the adhesive composition.

In some embodiments, the radiation curable adhesive composition optionally includes about 0.1 wt % to about 10 wt % of an optional photoinitiator, based on the total weight of the adhesive composition. A wide variety of photoinitiators may be used, and suitable examples include, but are not limited to, those available from BASF Resins, Wyandotte, Mich., under the trade designations IRGACURE 1173, IRGACURE 4265, IRGACURE 819, LUCIRIN TPO, LUCIRIN TPO-L, and DAROCUR 4265; optionally, a thermally activated free-radical initiator may be used. Thermal initiators useful in this invention include compounds that generate free radicals at moderately elevated temperatures. Suitable classes of thermal initiators include, but are not limited to thermally labile azo compounds and peroxides. Non-limiting examples of thermally labile azo compounds include those under the trade designation VAZO from the Chemours Company (Wilmington, Del.), such as 2,2′-azobisisobutyronirile, 2,2′-azobis-2-methylbutyronitrile, 2,2′-azobis-2-methylvaleronitrile, 2,2′-azobis-2,3-dimethylbutyronitrile, and combinations thereof and the like. Non-limiting examples of peroxides include, but are not limited to organic peroxides under the trade designation LUPEROX available from Arkema Inc. (Philadelphia, Pa.), and include cumene hydroperoxide, methyl ethyl ketone peroxide, benzoyl peroxide, di-t-butyl peroxide, di-t-amyl peroxide, t-butyl-cumyl peroxide, dicumyl peroxide, t-butyl hydroperoxide, t-butyl peracetate, di-n-propyl peroxydicarbonate and combinations thereof and the like.

In various example embodiments, which are not intended to be limiting, the radiation curable adhesive composition includes about 50 wt % to about 99 wt % of the difunctional monomer or difunctional oligomer with two methacryl functional groups, and about 1 wt % of a photoinitator. In various example embodiments, which are not intended to be limiting, the radiation curable adhesive composition includes about 50 wt % to about 95 wt % of the difunctional monomer or difunctional oligomer with two methacryl functional groups, about 5 wt % to about 50 wt % of a monofunctional (meth)acrylate monomer or monofunctional oligomer and about 1 wt % of a photoinitator. In other example embodiments, which are not intended to be limiting, the radiation curable adhesive composition includes about 50 wt % to about 95 wt % of the difunctional monomer or difunctional oligomer with two methacryl functional groups, about 5 wt % to about 50 wt % of a monofunctional acrylate monomer or monofunctional oligomer, and about 1 wt % of a photoinitator.

Referring to FIG. 2, in another aspect, the present disclosure is directed to a method of forming a quantum dot film article 100 including coating a radiation curable adhesive composition including quantum dots on a first barrier layer 102 and disposing a second barrier layer on the quantum dot material 104. In some embodiments, the method 100 includes a step 106 of polymerizing (e.g., radiation curing) the radiation curable adhesive composition to form a cured matrix.

In various embodiments, the radiation curable adhesive composition can be cured or hardened by applying radiation such as, for example, ultraviolet (UV) or visible light, or an electron beam. The radiation may be applied alone or in combination with thermal radiation such as infrared and heat.

In some example embodiments that are not intended to be limiting, radiation cure conditions can include applying about 10 mJ/cm² to about 4000 mJ/cm² of UVA, more preferably about 10 mJ/cm² to about 200 mJ/cm² of UVA. In some embodiments, heating and UV light may also be applied in combination.

In some embodiments, the radiation curable adhesive composition may be cured after lamination between the overlying barrier films 32, 34. Thus, the increase in viscosity of the adhesive composition locks in the coating quality right after lamination. By curing right after coating or laminating, in some embodiments the cured adhesive composition increases the viscosity of the adhesive composition to a point that the adhesive composition acts as an adhesive to hold the laminate together during further processing steps. In some embodiments, the radiation cure of the adhesive composition provides greater control over coating, curing and web handling as compared to traditional thermal curing of an epoxy adhesive composition.

Once at least partially cured, the adhesive composition forms a polymer network that provides a protective supporting matrix 24 for the quantum dots 22.

Edge ingress is defined by a loss in quantum dot performance due to ingress of moisture and/or oxygen into the matrix 24 (FIG. 1). In various embodiments, the edge ingress of moisture and oxygen into the cured matrix 24 is less than about 1.0 mm after 1 week at 85° C., or about less than 0.75 mm after 1 week at 85° C.

In various embodiments, the color change observed upon aging is defined by a change of less than 0.02 on the 1931 CIE (x,y) Chromaticity coordinate system following an aging period of 1 week at 85° C. or after two weeks of accelerated aging in a lifetime screening box (at a temperature of 85° C. and a light intensity of 152 watts per steradian per square meter). In certain embodiments, the color change upon aging is less than 0.005 on the following an aging period of 1 week at 85° C. or after two weeks of accelerated aging in a lifetime screening box (at a temperature of 85° C. and a light intensity of 152 watts per steradian per square meter).

In various embodiments, the external quantum efficiency of the quantum dot films using the adhesive matrix materials of the present disclosure is greater than about 70%, or greater than about 80%, or greater than about 85%.

In various embodiments, the luminance and external quantum efficiency of the quantum dot films using the adhesive matrix materials of the present disclosure was well preserved following an aging period of 1 week at 85° C.

In various embodiments, the thickness of the quantum dot layer 20 is about 40 μm to about 400 μm, or about 80 μm to about 250 μm.

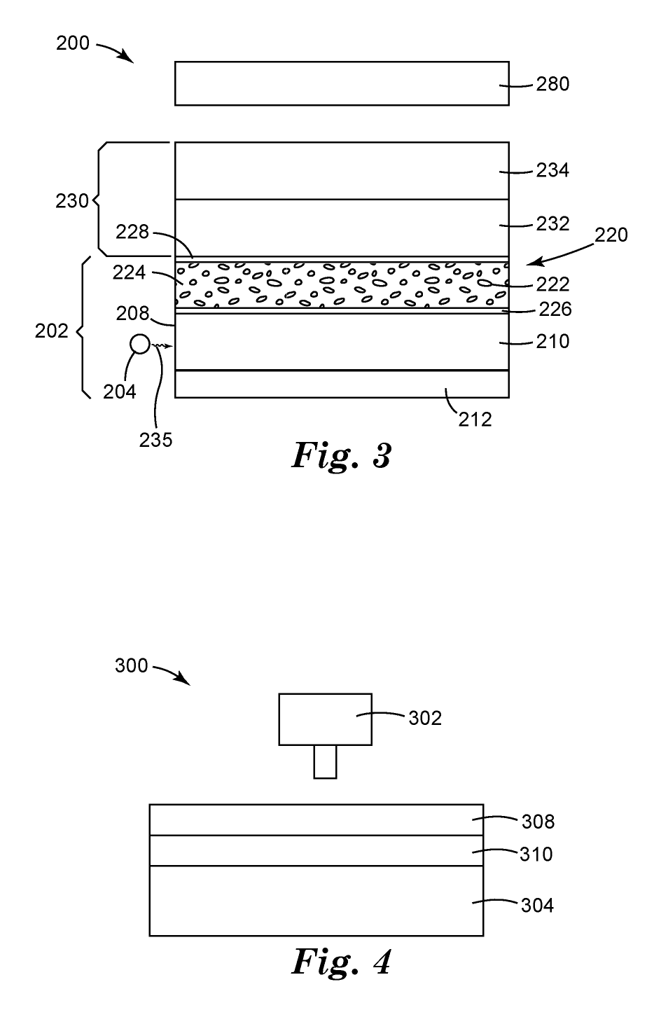

FIG. 3 is a schematic illustration of an embodiment of a display device 200 including the quantum dot articles described herein. This illustration is merely provided as an example and is not intended to be limiting. The display device 200 includes a backlight 202 with a light source 204 such as, for example, a light emitting diode (LED). The light source 204 emits light along an emission axis 235. The light source 204 (for example, a LED light source) emits light through an input edge 208 into a hollow light recycling cavity 210 having a back reflector 212 thereon. The back reflector 212 can be predominately specular, diffuse or a combination thereof, and is preferably highly reflective. The backlight 202 further includes a quantum dot article 220, which includes a protective matrix 224 having dispersed therein quantum dots 222. The protective matrix 224 is bounded on both surfaces by polymeric barrier films 226, 228, which may include a single layer or multiple layers.

The display device 200 further includes a front reflector 230 that includes multiple directional recycling films or layers, which are optical films with a surface structure that redirects off-axis light in a direction closer to the axis of the display. In some embodiments, the directional recycling films or layers can increase the amount of light propagating on-axis through the display device, this increasing the brightness and contrast of the image seen by a viewer. The front reflector 230 can also include other types of optical films such as polarizers. In one non-limiting example, the front reflector 230 can include one or more prismatic films 232 and/or gain diffusers. The prismatic films 232 may have prisms elongated along an axis, which may be oriented parallel or perpendicular to an emission axis 235 of the light source 204. In some embodiments, the prism axes of the prismatic films may be crossed. The front reflector 230 may further include one or more polarizing films 234, which may include multilayer optical polarizing films, diffusely reflecting polarizing films, and the like. The light emitted by the front reflector 230 enters a liquid crystal (LC) panel 280. Numerous examples of backlighting structures and films may be found in, for example, U.S. Published Application No. US 2011/0051047.

Various embodiments of the quantum dot film articles are provided that are a film, method, or adhesive composition.

Some of the advantages of the quantum dot film articles are further illustrated by the following examples. The particular materials, amounts and dimensions recited in these examples, as well as other conditions and details, should not be construed to unduly limit the present disclosure.

### EXAMPLES

### Materials Used

Barrier film (2 mil (0.05 mm) thickness))—available under the trade designation FTB3 from 3M Company (St. Paul Minn.).
Green CdSe Quantum Dot concentrate—Part # QCEF52035R2 available from NanoSys (Palo Alto, Calif.).
Red CdSe Quantum Dot concentrate—Part # QCEF62290P3-01 available from NanoSys (Palo Alto, Calif.).
CN154—a bisphenol A methacrylate oligomer available from Sartomer USA, LLC (Exton, Pa.).
SR340—a 2-phenoxyethyl methacrylate available from Sartomer USA, LLC (Exton, Pa.).
SR348—a bisphenol A dimethacrylate available from Sartomer USA, LLC (Exton, Pa.).
CN110—a difunctional epoxy acrylate oligomer available from Sartomer USA, LLC (Exton, Pa.).
SR349—a bisphenol A diacrylate available from Sartomer USA, LLC (Exton, Pa.).
SR339—a 2-phenoxyethyl acrylate available from Sartomer USA, LLC (Exton, Pa.).
TPO-L—a liquid photoinitiator available from BASF Resins (Wyandotte, Mich.).

### Example 1 (Comparative)

A white dot concentrate (Solution A) was prepared by combining 80% by weight of green CdSe quantum dot concentrate and 20% by weight of red quantum dot concentrate under a nitrogen atmosphere. Solution B (a UV curable matrix with difunctional acrylate monomer) was prepared by combining the components of Table 1, heating them in a microwave for 20 seconds, and then mixing them in a rotary shaker overnight until all the ingredients were fully fixed. Solution A was then added to Solution B at 4.76% by weight. The resulting mixture was mixed with a Cowles blade (available from Cowles Products, North haven CT) for 3 minutes at 1400 rpm.

Quantum dot articles were made by coating the resulting solution between two barrier films at a thickness of 100 micrometers using a knife coater. The coatings were cured for 60 seconds and 100% power with ultraviolet radiation using a Clearstone UV LED lamp (available from Clearstone Technologies, Inc., Hopkins Minn.) operating at a wavelength of 385 nm.

The resulting films were tested at three time intervals: immediately after coating, after one week of aging at 85° C., and after two weeks of accelerated aging in a lifetime screening box (at a temperature of 85° C. and a light intensity of 152 watts per steradian per square meter). Results from immediately after coating are shown in Table 5; results after one week are shown in Table 6 and accelerated aging results are shown in Table 7.

Transmission was measured using a BYK HazeGard Plus haze meter (available from BYK-Gardner, Columbia, Md.).

External quantum efficiency (EQE) was measured using an Absolute PL Quantum Yield Spectrometer C11347 (available from Hamamatsu Corporation, Middlesex N.J.).

Luminance and color (i.e., white point) were measured with a PR650 colorimeter (available from Photo Research Inc., Chatsworth Calif.) following the procedure described in pending U.S. provisional application No. 62/020,942. Color was quantified by placing the constructed film 310 into a recycling system 300 (FIG. 4) and measuring with the colorimeter 302. A gain cube 304 with a blue LED light was used with the film 310, which contained red and green quantum dots, and a micro-replicated brightness enhancement film 308 available from 3M, St. Paul, Minn., under the trade designation 3M BEF. A white point was achieved in this recycling system.

The color change observed upon aging was defined by the variation on the 1931 CIE (x,y) Chromaticity coordinate system following an aging period of 1 week at 85° C.

Edge ingress, which is defined by a loss in quantum dot performance due to ingress of moisture and/or oxygen into the quantum dot matrix 24 (FIG. 1), was tested by placing the coatings on a black light and measuring with a ruler how much of the edge was dark (i.e., did not illuminate).

Table 5 shows transmission, luminance, color point x- and y-coordinates, and EQE immediately after coating as well as EQE and solution quality after 24 hours.

Table 6 shows the changes in luminance, white point coordinates, EQE and edge ingress after one week.

Table 7 shows changes in luminance and white point and distance A x,y that the white point has moved after two weeks of accelerated aging.

TABLE 1
UV Curable Matrix with Difunctional Acrylate Monomer

| Material | Wt % |
|---|---|
| CN154 | 44.68% |
| (BPA methacrylate) | |
| SR349 | 44.68% |
| (BPA diacrylate) | |
| SR340 | 9.93% |
| (methacrylate) | |
| TPO-L | 0.66% |
| (photoinitiator) | |
| Sum | 100.0% |

### Example 2 (Comparative)

A solution was prepared and coated to make films as in Example 1 except that Solution C was used instead of Solution B. The components of Solution C are shown in Table 2. Solution C was a UV curable matrix with difunctional acrylate oligomer.

Films were tested as in Example 1. The results are shown in Tables 5, 6 and 7.

TABLE 2
UV Curable Matrix with Epoxy Acrylate
and Difunctional Methacrylate Oligomer

| Material | Wt % |
|---|---|
| CN110 | 44.68% |
| (difunctional acrylate) | |
| SR348 | 44.68% |
| (bisphenol A dimethacrylate) | |
| SR340 | 9.93% |
| (methacrylate) | |
| TPO-L | 0.66% |
| (photoinitiator) | |
| Sum | 100.0% |

### Example 3

A solution was prepared and coated to make films as in Example 1 except that Solution D was used instead of Solution B. The components of Solution D are shown in Table 3. Solution D was a UV curable matrix with difunctional methacrylates.

Films were tested as in Example 1. The results are shown in Tables 5, 6 and 7.

TABLE 3
UV Curable Matrix with Difunctional Methacrylate

| Material | Wt % |
|---|---|
| CN154 | 44.68% |
| (bisphenol A methacrylate) | |
| SR348 | 44.68% |
| (bisphenol A dimethacrylate) | |
| SR340 | 9.93% |
| (methacrylate) | |
| TPO-L | 0.66% |
| (photoinitiator) | |
| Sum | 100.0% |

### Example 4

A solution was prepared and coated to make films as in Example 1 except that Solution E was used instead of Solution B. The components of Solution E are shown in Table 4. Solution E was a UV curable matrix with a monofunctional acrylate.

Films were tested as in Example 1. The results are shown in Tables 5, 6 and 7.

TABLE 4
UV Curable Matrix with Difunctional Methacrylate
and Monofunctional Acrylate

| Material | Wt % |
|---|---|
| CN154 | 44.68% |
| (bisphenol A methacrylate) | |
| SR348 | 44.68% |
| (bisphenol A dimethacrylate) | |
| SR339 | 9.93% |
| (acrylate) | |
| TPO-L | 0.66% |
| (photoinitiator) | |
| Sum | 100.0% |

TABLE 5
Optical Characteristics of Quantum Dot Film Articles

| | | | | | | | 24 hr | |
|---|---|---|---|---|---|---|---|---|
| | | | | | | | pot | Solution |
| | | | Luminance | | | | life | Quality |
| Example | Matrix | % T | (cd/m²) | X | Y | EQE | EQE | at 24 hr |
| 1 | Solution B | 88.1 | 349.1 | 0.2193 | 0.2140 | 89.1% | N/A | gelled |
| (Comparative) | | | | | | | | |
| 2 | Solution C | 91.0 | 308.4 | 0.2123 | 0.1927 | 77.6% | N/A | gelled |
| (Comparative) | | | | | | | | |
| 3 | Solution D | 89.5 | 328.4 | 0.2131 | 0.2004 | 84.2% | 78.6% | good |
| 4 | Solution E | 88.3 | 315.9 | 0.2134 | 0.2049 | 81.2% | 76.1% | good |

TABLE 6
Performance Change of Quantum Dot Film Articles
After Aging for 1 Week at 85° C.

| | | Change in | | | Edge |
|---|---|---|---|---|---|
| | | Luminance | | Δ EQE | Ingress |
| Example | Matrix | (%) | Δ X, Y | (%) | (mm) |
| 1 (Comparative) | Solution B | −3% | 0.006 | −8.17% | 0.1 |
| 2 (Comparative) | Solution C | −7% | 0.015 | −2.24% | 0.6 |
| 3 | Solution D | 10% | 0.016 | 3.90% | 1.0 |
| 4 | Solution E | 12% | 0.013 | 5.96% | 0.7 |

TABLE 7
Performance Change of Quantum Dot Film Articles
After Accelerated Lifetime Aging

| | | Change in | | | |
|---|---|---|---|---|---|
| | | Luminance | | | |
| Example | Matrix | (%) | Δ x | Δ y | Δ x, y |
| 1 (comparative) | Solution B | −21.2% | −0.012 | −0.033 | 0.035 |
| 2 (comparative) | Solution C | −21.7% | −0.013 | −0.036 | 0.038 |
| 3 | Solution D | 0.9% | 0.001 | −0.001 | 0.002 |
| 4 | Solution E | −2.4% | −0.001 | −0.009 | 0.009 |

Table 6 shows that after one week at 85° C., the coated films of Examples 3 and 4 have increased EQE and luminance values. In contrast, films (such as those of Comparative Examples 1 and 2) that show a loss in EQE and luminance after thermal aging have historically had poor lifetimes. Table 6 also shows that the solutions of Comparative Examples 1 and 2 gelled while those of Examples 3 and 4 remain fluid. This stability has important consequences in a manufacturing environment.

Table 7 shows that the films of Examples 3 and 4 have very little change in color or luminance after two weeks of accelerated aging.

Various embodiments of the invention have been described. These and other embodiments are within the scope of the following claims.

1. A quantum dot film article comprising:
a first barrier layer;
a second barrier layer; and
a quantum dot layer between the first barrier layer and the second barrier layer, the quantum dot layer comprising quantum dots dispersed in a matrix comprising a cured radiation curable adhesive composition with external quantum efficiency of greater than about 70%, wherein the radiation curable adhesive composition comprises:
about 30 wt % to about 99 wt %, based on the total weight of the radiation curable adhesive composition comprising a multifunctional monomer, multifunction oligomer, or mixture thereof, wherein the multifunctional monomer comprises methacryl functional groups on a backbone.

2. The quantum dot film article of claim 1, wherein the multifunctional monomer and multifunction oligomer have an acid value from the presence of hydroxyl or carboxylic acid groups of greater than or equal to 0.2 mg of KOH/g.

3. The quantum dot film article of claim 1, wherein the quantum dot layer has an external quantum efficiency of greater than about 80%.

4. The quantum dot film article of claim 1, wherein the backbone on the multifunctional monomer or oligomer is derived from bisphenol A.

5. The quantum dot film article of claim 1, wherein the radiation curable adhesive composition further comprises a monofunctional (meth)acryl monomer or oligomer.

6. The quantum dot film article of claim 1, wherein the radiation curable adhesive composition further comprises a monofunctional methacryl monomer or oligomer.

7. The quantum dot film article of claim 6, wherein the radiation curable adhesive composition further comprises a monofunctional acryl monomer or oligomer.

8. The quantum dot film article of claim 1, wherein the radiation curable adhesive composition further comprises a photoinitiator.

9. The quantum dot film article of claim 1, wherein the quantum dots in the radiation curable adhesive composition are dispersed in an amino-functional silicone oil.

10. The quantum dot film article of claim 1, wherein the quantum dots comprise CdSe.

11. The quantum dot film article of claim 1, wherein the matrix further comprises scattering particles having an average size in a range from 1 to 10 micrometers.

12. The quantum dot film article of claim 1, wherein at least one of the first and the second barrier layer comprises at least one polymeric film.

13. The quantum dot film article of claim 1, wherein the quantum dot film article has an edge ingress of moisture and oxygen into the cured radiation curable adhesive composition of less than about 1.0 mm after 1 week at 85° C.

14. The quantum dot film article of claim 13, wherein the quantum dot film article has an edge ingress of moisture and oxygen into the cured radiation curable adhesive composition of less than about 0.75 mm after 1 week at 85° C.

15. The quantum dot film article of claim 1, wherein the quantum dot film article has a color change of less than 0.02 on the 1931 CIE (x,y) Chromaticity coordinate system following an aging period of 1 week at 85° C.

16. The quantum dot film article of claim 15, wherein the quantum dot film article has a color change of less than 0.005 on the 1931 CIE (x,y) Chromaticity coordinate system following an aging period of 1 week at 85° C.

17. A quantum dot film article comprising:
a first barrier layer;
a second barrier layer; and
a quantum dot layer between the first barrier layer and the second barrier layer, the quantum dot layer comprising quantum dots in a matrix comprising a cured radiation curable adhesive composition with an external quantum efficiency of greater than about 70%, wherein the quantum dots are dispersed in an amino-functional silicone oil, and wherein the radiation curable adhesive composition comprises:
about 50 wt % to about 95 wt %, based on the total weight of the radiation curable adhesive composition, of a difunctional monomer or oligomer with two methacryl functional groups on a backbone derived from bisphenol A;
about 1 wt % to about 30 wt %, based on the total weight of the radiation curable adhesive composition, of at least one monofunctional monomer or oligomer with a (meth)acryl functional group; and
a photoinitiator.

18. The quantum dot film article of claim 17, wherein the quantum dot lam has an external quantum efficiency of greater than about 80%.

19. The quantum dot film article of claim 17, wherein the difunctional monomer or oligomer with two methacryl functional groups on a backbone derived from bisphenol A has an acid value from the presence of hydroxyl or carboxylic acid groups of greater than or equal to 0.2 mg of KOH/g.

20. The quantum dot film article of claim 17, wherein the radiation curable adhesive composition comprises:
about 50 wt % to about 95 wt %, based on the total weight of the radiation curable adhesive composition, of a difunctional monomer or oligomer with two methacryl functional groups on a backbone derived from bisphenol A;
about 1 wt % to about 30 wt %, based on the total weight of the radiation curable adhesive composition, of at least one monofunctional monomer or oligomer with an acryl functional group; and
a photoinitiator.

21. The quantum dot film article of claim 17, wherein the matrix further comprises scattering particles having an average size in a range from 1 to 10 micrometers.

22. The quantum dot film article of claim 17, wherein at least one of the first and the second barrier layer comprises at least one polymeric film.

23. A display device comprising the quantum dot film article of claim 1.

24. A method of forming a quantum dot film article comprising coating a quantum dot material on a first polymeric film, the quantum dot material comprising quantum dots in an adhesive composition comprising:
about 30 wt % to about 99 wt %, based on the total weight of the radiation curable adhesive composition, of a difunctional monomer or oligomer with two methacryl functional groups on a backbone derived from bisphenol A, wherein the difunctional monomer or oligomer with two methacryl functional groups on a backbone derived from bisphenol A has an acid value of greater than about 0.2 mg of KOH/g; and a photoinitiator.

25. The method of claim 24, wherein the radiation curable adhesive composition further comprises a monofunctional (meth)acryl monomer or oligomer.

26. The method of claim 24, wherein the radiation curable adhesive composition further comprises a monofunctional methacryl monomer or oligomer.

27. The method of claim 24, wherein the radiation curable adhesive composition further comprises a monofunctional acryl monomer or oligomer.

28. The method of any of claim 24, further comprising applying a second polymeric film on the adhesive composition.

29. The method of claim 24, further comprising curing the adhesive composition with UV light.

30. A display device comprising the quantum dot film article of claim 17.
